(19) United States
(12) Patent Application Publication
(10) Pub. No.: US 2017/0168618 A1
(43) Pub. Date: Jun. 15, 2017

(54) IN-CELL TOUCH DISPLAY, DRIVE METHOD THEREOF, AND DISPLAY DEVICE

(71) Applicants: Boe Technology Group Co., Ltd., Beijing (CN); Beijing Boe Optoelectronics Technology Co., Ltd., Beijing (CN)

(72) Inventors: Xiaoliang Ding, Beijing (CN); Xue Dong, Beijing (CN); Haisheng Wang, Beijing (CN); Xiaochuan Chen, Beijing (CN); Hongjuan Liu, Beijing (CN); Shenji Yang, Beijing (CN); Yingming Liu, Beijing (CN); Weijie Zhao, Beijing (CN); Changfeng Li, Beijing (CN); Wei Liu, Beijing (CN); Lei Wang, Beijing (CN); Rui Xu, Beijing (CN); Tao Ren, Beijing (CN); Xiaobo Xie, Beijing (CN)

(21) Appl. No.: 15/037,802

(22) PCT Filed: Oct. 20, 2015
(86) PCT No.: PCT/CN2015/092286

§ 371 Date: May 19, 2016

(30) Foreign Application Priority Data
Jun. 29, 2015 (CN) 201510369808.1

(51) Int. Cl. G06F 3/041; G02F 1/1333; G06F 3/044

(52) U.S. Cl. CPC G06F 3/0412; G06F 3/044; G06F 3/0416; G02F 1/13338; G06F 2203/04103

(57) ABSTRACT

An in-cell touch display, a drive method thereof, and a display device. When the touch display is in a display phase, each common electrode region is supplied with a common electrode signal via a respective connection line, and the data lines are supplied with respective data signals. When the touch display is in a touch control phase, the plurality of common electrode blocks in each common electrode region are used as touch control driving electrodes and supplied with a touch control driving signal through the respective connection line, and at least a portion of the data lines are used as touch control sensing signal lines for transmission of generated touch control sensing signals.

### CROSS-REFERENCE TO THE RELATED APPLICATIONS

The present application is the U.S. national phase entry of PCT/CN2015/092286, with an international filing date of Oct. 20, 2015, which claims the benefit of Chinese Patent Application No. 201510369808.1, filed on Jun. 29, 2015, the entire disclosures of which are incorporated herein by reference.

### TECHNICAL FIELD

The present disclosure relates to the field of displays, and particularly to an in-cell touch display, a drive method thereof, and a display device.

### BACKGROUND

At present, touch displays, as input devices, provide a user with better interaction experience as compared with keyboards and mice. According to their implementation principles, touch displays may be classified into resistive touch displays, capacitive touch displays, surface acoustic wave touch displays, infrared touch displays, and the like. Currently, the resistive type and capacitive type touch display technologies are used extensively.

The capacitive touch display is becoming the preferred type due to its advantages, such as higher sensitivity and capability of multi-point touch control. A basic principle of the capacitive touch display is as follows: a drive voltage is applied to a driving signal line, and a signal change is detected on a sensing signal line. The driving signal line determines a coordinate in an X-axis direction, and the sensing signal line determines a coordinate in a Y-axis direction. As such, each of intersections of the driving signal lines and the sensing signal lines corresponds to a respective coordinate. In the touch control phase, the driving signal lines in the X-axis direction are scanned line by line, and a signal on each sensing signal line is read while each of the driving signal lines is scanned. Each of the intersections may be scanned through one round of scanning. Assume that the scanning is performed x*y times, wherein x represents the number of driving signal lines, and y represents the number of sensing signal lines, then there are totally x*y intersections of the driving signal lines and the sensing signal lines. Such detection manner may be used to determine multi-point coordinates, thereby implementing multi-point touch.

FIG. 1 is a schematic diagram of the detection principle of a touch display in the prior art, wherein 101 represents a signal source, 103 represents a resistor of the driving signal line, 102 represents a mutual capacitance between the driving signal line and the sensing signal line, 104 represents a parasitic capacitance between the driving signal line and a common electrode layer, 105 represents a parasitic capacitance between the sensing single line and the common electrode layer, 106 represents a resistor of the sensing signal line, and 107 represents a detection circuit. When a finger touches the touch display, a portion of current is drained off by the finger, which is equivalent to a change in the mutual capacitance 102 between the driving signal line and the sensing signal line. A weak change in the current that is caused by the finger draining off the current may be detected by the detection circuit 107, and thereby a touch control position may be determined.

However, the capacitive touch display that is applied most extensively at present is the add-on touch display where a touch panel and a liquid crystal display (LCD) are produced separately and then adhered to each other. Due to a series of factors such as high manufacturing cost, low light transmittance and a large module thickness, use of such prior art touch displays is limited.

### SUMMARY

Embodiments of present disclosure provide an in-cell touch display, a drive method thereof, and a display device, which seek to achieve a thinner screen thickness, lower manufacturing cost and higher light transmittance.

According to a first aspect of the present disclosure, an in-cell touch display is provided comprising: a color filter substrate; and an array substrate comprising data lines and gate lines insulated from and intersecting with each other, a plurality of connection lines, and a plurality of common electrode regions, each of the plurality of common electrode regions comprising a plurality of common electrode blocks arranged in a matrix and connected with each other via a respective one of the plurality of connection lines. When the touch display is in a display phase, each common electrode region is supplied with a common electrode signal via the respective connection line, and the data lines are supplied with respective data signals. When the touch display is in a touch control phase, the plurality of common electrode blocks in each common electrode region serve as touch control driving electrodes and being supplied with a touch control driving signal through the respective connection line, and at least a portion of the data lines serve as touch control sensing signal lines for transmission of generated touch control sensing signals.

In some embodiments, each of the plurality of common electrode regions comprises one or more rows of common electrode blocks arranged in a matrix.

In some embodiments, the array substrate further comprises a plurality of sub-pixel cells each comprising a pixel electrode, and each of the common electrode blocks corresponds to a respective pixel electrode.

In some embodiments, a projection of each of the common electrodes on the array substrate does not overlap projections of the data lines and the gate lines on the array substrate.

In some embodiments, the common electrode blocks are arranged on the same layer as the gate lines or the data lines.

In some embodiments, the connection lines are arranged on the same layer as the common electrode blocks; or the connection lines are located above the common electrode blocks; or the connection lines are located below the common electrode blocks.

In some embodiments, the connection lines are arranged on the same layer as the gate lines and insulated from the gate lines.

In some embodiments, the connection lines are made of a metallic material.

In some embodiments, the touch display further comprises a plurality of touch control driving signal channels for supplying the plurality of connection lines with the touch control driving signals, each touch control driving signal channel being connected with at least one connection line.

In some embodiments, the touch display further comprises a plurality of touch control sensing signal channels for acquiring the generated touch control sensing signals from the at least a portion of the data lines serving as the touch control sensing signal lines, each touch control sensing signal channel being connected with at least one data line.

In some embodiments, the number of the plurality of touch control driving signal channels and the plurality of touch control sensing line channels is determined according to a desired touch control precision.

In some embodiments, the touch display further comprises a plurality of switching elements configured to operate selectively depending on whether the touch display is in a display phase or a touch control phase, such that the at least a portion of the data lines serving as the touch control sensing signal lines are supplied with the data signals in the display phase and transmit the generated touch control sensing signals in the touch control phase.

In some embodiments, each of the plurality of switching elements is an analog switch.

According to a second aspect of the present disclosure, a method of driving the in-cell touch display as described in the first aspect is further provided, comprising: when the touch display is in the display phase, supplying the common electrode signals to the connection lines, and supplying the data signals to the data lines; and when the touch display is in the touch control phase, supplying the touch control driving signals to the connection lines, and transmitting the generated touch control sensing signals through the at least a portion of the data lines serving as the touch control sensing signal lines.

According a third aspect of the present disclosure, a display device is further provided comprising the in-cell touch display as described in the first aspect.

Embodiments of the present disclosure have the advantages that the thickness of the touch display may be reduced, the light transmittance of the screen may be increased, and the manufacturing cost may be decreased, with the common electrode blocks being reused as touch control driving electrodes, and the data lines as touch control sensing signal lines.

### BRIEF DESCRIPTION OF THE DRAWINGS

FIG. 1 is a schematic diagram of the detection principle of a touch display in the prior art;

FIG. 2 is a structural schematic view of an in-cell touch display according to an embodiment of the present disclosure;

FIG. 3 is a schematic top view of a common electrode region in an in-cell touch display according to an embodiment of the present disclosure;

FIG. 4 is a schematic top view of a common electrode region in another in-cell touch display according to an embodiment of the present disclosure;

FIG. 5 is a schematic view of the wiring of gate lines and connection lines in an in-cell touch display according to an embodiment of the present disclosure;

FIG. 6 is a structural schematic view of an in-cell touch display according to an embodiment of the present disclosure;

FIG. 7 is a structural schematic view of a display/touch control function switching member in an in-cell touch display according to an embodiment of the present disclosure;

FIG. 8 is a flow chart of a method of driving an in-cell touch display according to an embodiment of the present disclosure; and

FIG. 9 is a schematic waveform diagram of a touch control driving signal and a common electrode signal for an in-cell touch display according to an embodiment of the present disclosure.

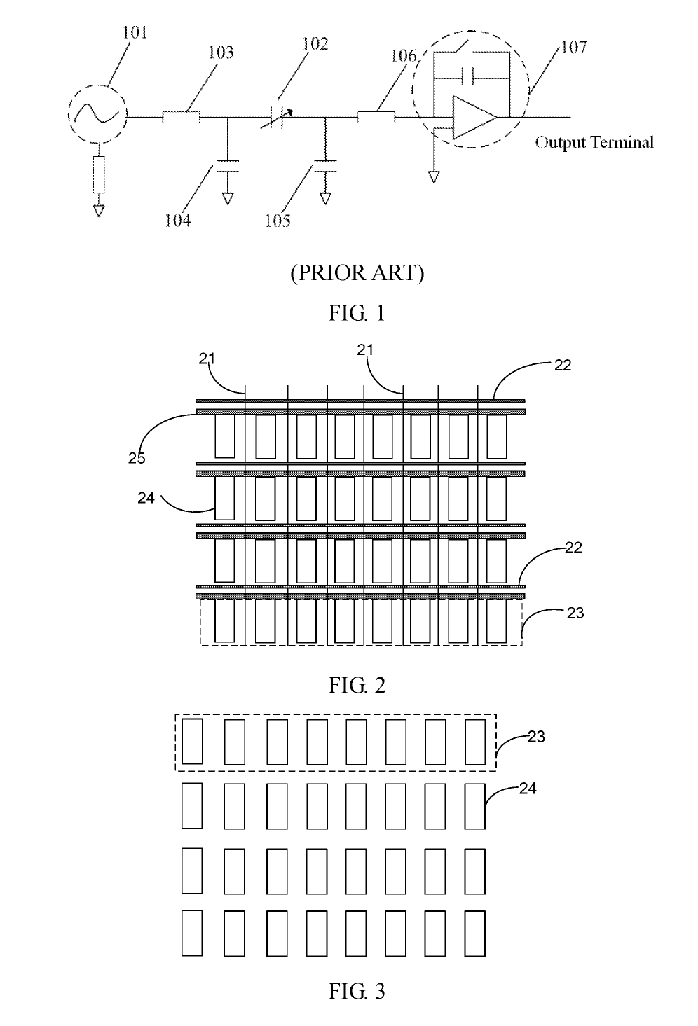

### DETAILED DESCRIPTION

The present disclosure will be described in detail with reference to the drawings to make objectives, technical solutions, and advantages of the present disclosure more apparent.

FIG. 2 is a structural schematic view of an in-cell touch display according to an embodiment of the present disclosure. The in-cell touch display may be based on an In-Plane Switch (IPS) technology or an Advanced Super Dimension Switch (ADS) technology where a common electrode is disposed on the array substrate. More specifically, the touch display may comprise an array substrate and a color filter substrate (not shown). The array substrate comprises data lines 21 and gate lines 22 which are insulated from and intersected with each other, a plurality of connection lines 25, and a plurality of common electrode regions 23. Each common electrode region 23 comprises a plurality of common electrode blocks 24 arranged in a matrix, and the plurality of common electrode blocks 24 in each common electrode region 23 are connected via a respective connection line 25.

When the display is in a display phase, each common electrode region 23 is supplied with a common electrode signal via the respective connection line 25, and the data lines 21 are supplied with respective data signals. When the display is in a touch control phase, the common electrode blocks 24 in each common electrode region 23 are used as touch control driving electrodes and supplied with a touch control driving signal through the respective connection line 25, and at least a portion of the data lines 21 are used as touch control sensing signal lines for transmission of generated touch control sensing signals.

In the embodiment, the common electrode is divided into blocks with a sub-pixel cell as a unit, and each common electrode block may correspond to a pixel electrode of a corresponding sub-pixel cell. In the text, the so-called sub-pixel cell is a region surrounded by the data line and the gate line which are insulated from and intersected with each other. Each sub-pixel cell comprises a thin film transistor (TFT), of which the gate is connected with the gate line, the source with the data line, and the drain with the pixel electrode. Since the common electrode is divided into blocks, the load of each data line is smaller, such that the in-cell touch display is suitable for applications of large-sized panels. However, embodiments of the present disclosure are not limited to the applications of large-sized panels.

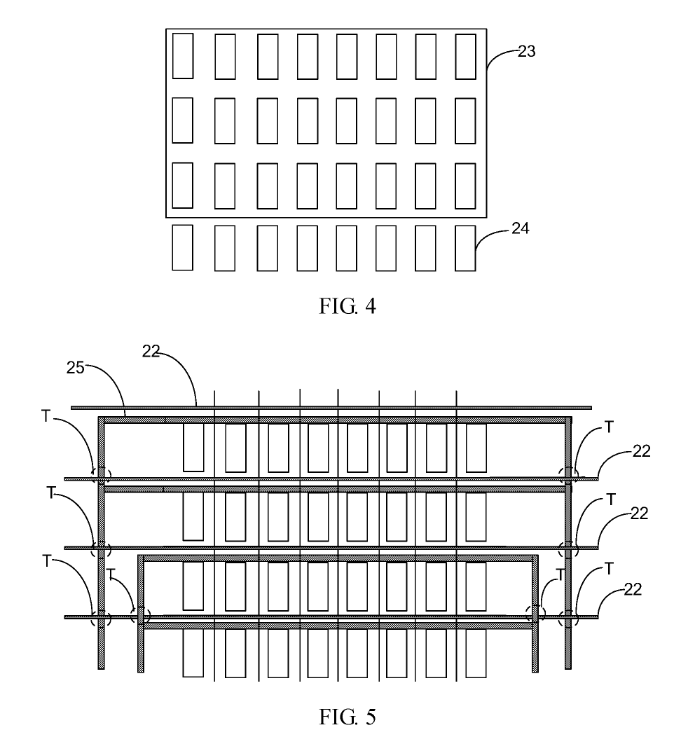

FIGS. 3 and 4 show schematic top views of two types of exemplary common electrode regions. In the example shown in FIG. 3, each common electrode region 23 comprises a row of common electrode blocks 24 arranged in a matrix. In the example shown in FIG. 4, each common electrode region 23 comprises three rows of common electrode blocks 24 arranged in a matrix. Of course, each common electrode region 23 may comprise more or less rows of common electrode blocks 24. In some embodiments, a projection of each common electrode block 24 on the array substrate does not overlap projections of the data lines 21 and the gate lines 22 on the array substrate. This facilitates reduction of the parasitic capacitance between the common electrode blocks 24 and the data lines 21 and the parasitic capacitance between the common electrode blocks 24 and the gate lines 22. Since the common electrode blocks 24 are reused as touch control driving electrodes, and (at least a portion of) the data lines 21 as touch control sensing signal lines, the parasitic capacitance between the touch control driving electrodes and the touch control sensing signal lines, and thus the time delay caused in transmission of the touch control driving signal by the touch control driving electrodes, are also reduced, thereby improving the accuracy of touch control detection. Generally, the data line does not affect the aperture ratio of the display, so reusing the data lines as the touch control sensing signal lines does not affect the aperture ratio of the touch display. In addition, as the common electrode blocks 24 are disposed in one-to-one correspondence with the pixel electrodes, there is no need for an extra mask plate, thus reducing the production cost.

By way of example, and not limitation, the common electrode blocks 24 may be arranged on the same layer as the gate lines 22. Alternatively, the common electrode blocks 24 may be arranged on the same layer as the data lines 21. Moreover, the connection lines 25 and the common electrode blocks 24 may be arranged on the same layer. Alternatively, the connection lines 25 may be located above or below the common electrode blocks 24. No insulating layer is needed between the common electrode blocks 24 and the connection lines 25, because the common electrode blocks 24 may be connected directly with the connection lines 25. In some embodiments where the connection lines 25 and the common electrode blocks 24 are not arranged on the same layer, each row of common electrode blocks 24 may be connected with the connection lines 25 through a via. The connection lines 25 may also be arranged on the same layer as the gate lines 22 and insulated from the gate lines 22. In this case, the connection lines 25 may be made of the same metallic material as the gate line 22, such as aluminum, copper, and the like.

FIG. 5 is a schematic view of the wiring of gate lines and connection lines in an in-cell touch display according to an embodiment of the present disclosure. When the connection lines 25 and gate lines 22 are arranged on the same layer, they may contact with each other. As shown in FIG. 5, there is a crossing region T between the first connection line 25 and the second gate line 22. To avoid the contact between the connection line 25 and the gate line 22, the gate line 22 and the connection line 25 may be connected at the region T through a source-drain metallic layer of a TFT in a jumper wiring manner. Specifically, the gate line 22 may be wired at the region T through a jumper of the source-drain metallic layer of the TFT, or the connection line 25 may be wired at the region T through a jumper of the source-drain metallic layer of the TFT.

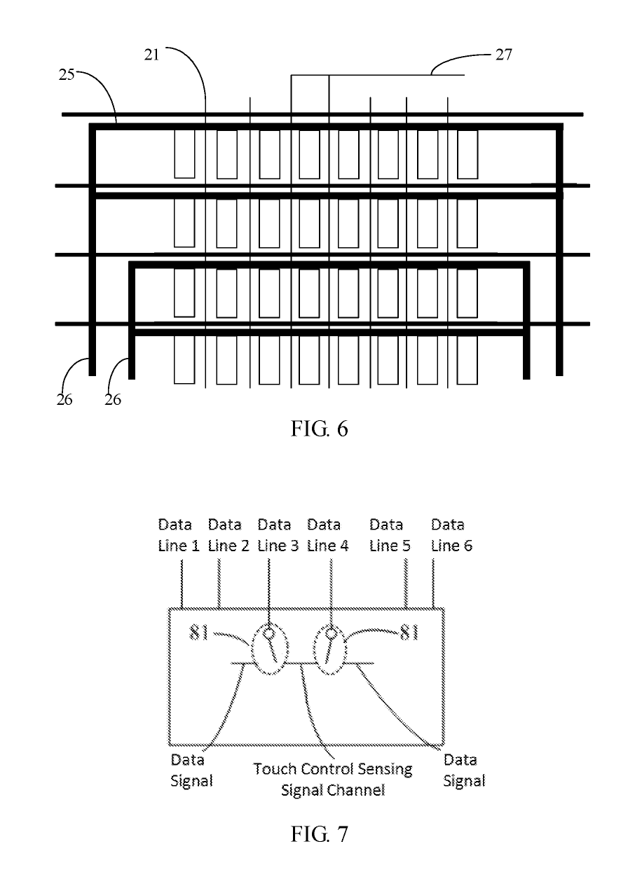

FIG. 6 is a structural schematic view of an in-cell touch display according to an embodiment of the present disclosure. The touch display further comprises a plurality of touch control driving signal channels 26 for supplying the touch control driving signals, and a plurality of touch control sensing signal channels 27 for acquiring the generated touch control sensing signals. One touch control driving signal channel 26 may be connected with one or more (adjacent) connection lines 25, and one touch control sensing signal channel 27 may be connected with one or more (adjacent) data lines 21. In the example as shown in FIG. 6, the first and second rows of connection lines 25 are connected with a single one touch control driving signal channel 26, and the third and fourth columns of data lines 21 are connected with a single one touch control sensing signal channel 27.

The number of touch control driving signal channels 26 and the number of connection lines 25 connected with each touch control driving signal channel 26 may be determined according to a desired touch control precision. In an example, a touch control driving signal channel 26 may be connected with a plurality of adjacent connection lines 25 such that a distance between the first connection line and the last connection line that are connected with the touch control driving signal channel 26 is 5 mm to 7 mm. Generally, assume that m represents a distance between the first connection line and the last connection line that are connected with one touch control driving signal channel, n represents a distance between two adjacent connection lines, and x represents the number of connection lines to be connected by one touch control driving signal channel, then x=m/n.

Similarly, the number of touch control sensing signal channels 27 and the number of connection lines 21 connected with each touch control sensing signal channel 27 may be determined according to a desired touch control precision. Specifically, assume that a represents a width of a touch display, b represents a distance between two adjacent touch control sensing signal channels 27, and c represents the number of the desired touch control sensing signal channels 27, then c=a/b. Further, the number of data lines 21 connected by each touch control sensing signal channel 27 may be determined according to a distance between two adjacent columns of data lines 21 and a distance between the first column of data line and the last column of data line that are connected with one touch control sensing signal channel 27. Specifically, assume that d represents the distance between two adjacent columns of data lines, e represents the distance between the first column of data line and the last column of data line that are connected with one touch control sensing signal channel 27, and f represents the number of data lines 21 connected with one touch control sensing signal channel 27, then f=e/d.

FIG. 7 is a structural schematic view of a display/touch control function switching member in an in-cell touch display according to an embodiment of the present disclosure. Continuing with the example shown in FIG. 6, the third column of data line and the fourth column of data line are reused as the touch control sensing signal lines. As shown in FIG. 7, the display/touch control function switching member may be a switching element 81. The switching element 81 operates selectively depending on whether the display is in a display phase or a touch control phase, such that the at least a portion of the data lines 21 serving as the touch control sensing signal lines are supplied with the data signals in the display phase and transmit the generated touch control sensing signals in the touch control phase. Specifically, when the touch display is in the touch phase, the switching element 81 is controlled by a control circuit to supply the data signal to the corresponding data line 21, and when the touch display is in the touch control phase, the switching element 81 is controlled by the drive circuit to connect the corresponding data line 21 to the touch control sensing signal channel to transmit the generated touch control sensing signal.

According to another aspect of the present disclosure, a display device is further provided comprising the above-mentioned in-cell touch display. Details of the in-cell touch display have been described above, and will not be repeated here.

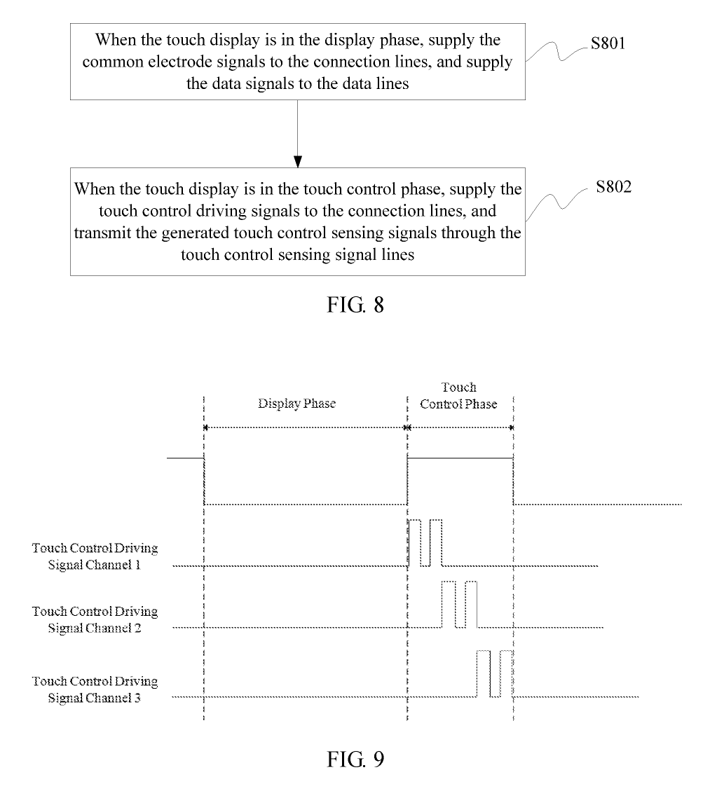

FIG. 8 is a flow chart of a method of driving an in-cell touch display according to an embodiment of the present disclosure. As shown in FIG. 8, the method comprises the following steps.

At S801, when the touch display is in the display phase, the common electrode signals are supplied to the connection lines, and the data signals are supplied to the data lines.

At S802, when the touch display is in the touch control phase, the touch control driving signals are supplied to the connection lines, and the generated touch control sensing signals are transmitted through the at least a portion of the data lines serving as the touch control sensing signal lines.

FIG. 9 is a schematic waveform diagram of a touch control driving signal and a common electrode signal for an in-cell touch display according to an embodiment of the present disclosure. As shown in FIG. 9, when the touch display is in the display phase, the touch control driving signal channels each receive a common electrode signal (Vcom) provided by the drive circuit to supply a display voltage to the common electrode blocks connected with the touch control driving signal channel, and when the touch display is in the touch control phase, the touch control driving signal channels each receive a touch control driving signal (shown as a square-wave signal in the figure) provided by the drive circuit to supply a touch control driving signal to the common electrode blocks connected with the touch control driving signal channel.

As is shown, a period (V-sync) for each frame of the touch display is divided into a display phase and a touch control phase. For example, if a time interval for displaying a frame of the touch display is 16.7 ms, then 5 ms may be selected as the touch control phase, and the remaining 11.7 ms as the display phase. Other alternatives are also possible.

While the disclosure has been illustrated and described in detail in the drawings and foregoing description, such illustration and description are to be considered illustrative or exemplary and not restrictive. Thus, the disclosure is not limited to the disclosed embodiments.

Various modifications and variations to embodiments of the present disclosure may be made by those skilled in the art without departing from the spirit and scope of the present disclosure. Thus, if these modifications and variations fall within the scope of the claims of the present disclosure and equivalents thereof, the present disclosure is intended to encompass these modifications and variations.

1. An in-cell touch display, comprising:
an array substrate comprising a plurality of data lines and a plurality of gate lines insulated from and intersecting with each other;
a plurality of connection lines; and
a plurality of common electrode regions, each of the plurality of common electrode regions comprising a plurality of common electrode blocks arranged in a matrix and connected with each other via a respective one of the plurality of connection lines;
wherein, when the touch display is in a display phase, each common electrode region is supplied with a common electrode signal via the respective connection line, and the data lines are supplied with respective data signals; and
wherein when the touch display is in a touch control phase, the plurality of common electrode blocks in each common electrode region serve as touch control driving electrodes and being supplied with a touch control driving signal through the respective connection line, and at least one of the data lines serves as a touch control sensing signal line for transmission of generated touch control sensing signals.

2. The touch display according to claim 1, wherein each of the plurality of common electrode regions comprises one or more rows of common electrode blocks arranged in a matrix.

3. The touch display according to claim 1, wherein the array substrate further comprises a plurality of sub-pixel cells each comprising a pixel electrode, and wherein each of the common electrode blocks corresponds to a respective pixel electrode.

4. The touch display according to claim 1, wherein a projection of each of the common electrodes on the array substrate does not overlap projections of the data lines and the gate lines on the array substrate.

5. The touch display according to claim 1, wherein the common electrode blocks are arranged on the same layer as one of the gate lines and the data lines.

6. The touch display according to claim 1, wherein the connection lines are arranged on the same layer as the common electrode blocks.

7. The touch display according to claim 5, wherein the connection lines are arranged on the same layer as the gate lines and insulated from the gate lines.

8. The touch display according to claim 1, wherein the connection lines are made of a metallic material.

9. The touch display according to claim 1, further comprising a plurality of touch control driving signal channels for supplying the plurality of connection lines with the touch control driving signals, wherein each touch control driving signal channel is connected with at least one connection line.

10. The touch display according to claim 9, further comprising a plurality of touch control sensing signal channels for acquiring the generated touch control sensing signals from the data lines serving as the touch control sensing signal lines, wherein each touch control sensing signal channel is connected with at least one data line.

11. The touch display according to claim 10, wherein the number of the plurality of touch control driving signal channels and the plurality of touch control sensing signal channels is determined according to a desired touch control precision.

12. The touch display according to claim 1, further comprising a plurality of switching elements configured to operate selectively depending on whether the touch display is in the display phase or the touch control phase, such that the data lines serving as the touch control sensing signal lines are supplied with the data signals in the display phase and transmit the generated touch control sensing signals in the touch control phase.

13. The touch display according to claim 12, wherein each of the plurality of switching elements is an analog switch.

14. A method of driving the in-cell touch display according to claim 1, comprising:
when the touch display is in the display phase, supplying the common electrode signals to the connection lines, and supplying the data signals to the data lines; and
when the touch display is in the touch control phase, supplying the touch control driving signals to the connection lines, and transmitting the generated touch control sensing signals through the data lines serving as the touch control sensing signal lines.

15. A display device, comprising the in-cell touch display according to claim 1.

16. The touch display according to claim 1, wherein the connection lines are located above the common electrode blocks.

17. The touch display according to claim 16, wherein the connection lines are arranged on the same layer as the gate lines and insulated from the gate lines.

18. The touch display according to claim 1, wherein the connection lines are located below the common electrode blocks.

19. The touch display according to claim 18, wherein the connection lines are arranged on the same layer as the gate lines and insulated from the gate lines.

20. The touch display according to claim 6, wherein the connection lines are arranged on the same layer as the gate lines and insulated from the gate lines.
